(19) United States
(12) Patent Application Publication
(10) Pub. No.: US 2003/0230379 A1
(43) Pub. Date: Dec. 18, 2003

(54) Two-sided lamination method for controlling curl

(76) Inventor: Marc L. Roubik, Glendale, AZ (US)

Correspondence Address: HOGAN & HARTSON LLP, ONE TABOR CENTER, SUITE 1500, 1200 SEVENTEENTH ST, DENVER, CO, 80202, US

(21) Appl. No.: 10/460,076

(22) Filed: Jun. 12, 2003

Related U.S. Application Data
(60) Provisional application No. 60/388,880, filed on Jun. 14, 2002.

(51) Int. Cl. B32B 31/00

(52) U.S. Cl. 156/229; 156/163; 428/212

(57) ABSTRACT

A two-sided lamination process controlling curl caused by memory in laminate material, such as polyester, polypropylene, or nylon. The method involves matching or aligning the grain orientation of a top laminate sheet or film with the grain orientation of a bottom laminate sheet or film. The method includes selecting laminating films from the same position on the stretched or oriented web for the top and bottom laminating films. To achieve opposing forces, opposite sides of the web from a particular web position are coated with thermally activated adhesive to form the top and bottom laminating materials or supply rolls. Rolls of the two types of laminating material are then fed concurrently to a laminator to coat opposite sides of a substrate with laminate films with grain orientation or memory that creates substantially equal bending forces but in opposite directions.

### CROSS-REFERENCE TO RELATED APPLICATIONS

This application claims the benefit of U.S. Provisional Application No. 60/388,880, filed Jun. 14, 2002, which is incorporated by reference herein in its entirety.

### BACKGROUND OF THE INVENTION

1. Field of the Invention.

The present invention relates generally to the field of thermal lamination, and more particularly, to a method, and products made by such method, of laminating a substrate on both sides with first and second laminate sheets specifically selected and orientated to control curl of the finished product by providing similar or even identical but opposing bending or curling forces on each side of the substrate.

2. Relevant Background.

Lamination has increasingly become the chosen process for finishing and protecting an ever-increasing number of products. Lamination is used to protect a printed substrate, such as paper, cardboard, or plastic, with one or more protective film layers. Laminated products include identification cards, menus, photographs, trading cards, buttons, book covers, folding cartons, pocket folders, point of purchase displays, and many other products, such as blinds and shades in the window covering industry, for which it is desirable to protect a substrate. Printed materials or media are laminated to protect them from the elements such as moisture, abrasive particles, chemicals, and fingerprinting, and such protection significantly extends the service life of the product. Many of these products are printed on both sides or opposing sides of the substrate, such as identification cards, and the demand for two-sided laminated products to protect both sides of printed material is expected to rapidly expand.

Thermal lamination is one of the most common methods of applying a laminating layer over a substrate and numerous laminating processes and machines, i.e., laminators, have been created to automate the laminating process. In thermal lamination, a printed substrate is covered with a protective film layer that is bound to the substrate, e.g., in two-sided thermal lamination two film layers are bound to opposing sides of the substrate. The materials used for the thin film are typically polyester (PET), polypropylene (OPP), and nylon but other plastics and plastic composites are used and are being developed (such as semitone) for use in thermal lamination. The laminate material or lamina is typically provided to the laminator in a supply roll, and the laminate material includes the laminate layer of PET, OPP, nylon, or other plastic with a layer of adhesive applied to one side. In typical laminators, the substrate is fed concurrently with the laminate material to meet in a convergence zone of the laminator at which point the laminate material is attached to one or both sides of the substrate with the adhesive.

The term “thermal” is used to describe the adhesive and the process in which the adhesive bonds the laminate layer or film to the substrate. In general, the adhesive is a resin that is applied in an extrusion coating process to one side of the sheet or web of the laminating material, which is then rolled to form a supply roll for the laminator. The specific chemical make up of the adhesive may vary but, in general, the adhesives are activated by heating. For example, many adhesives contain polyethylene-based resins that melt at temperatures around 180 to 300° F. The adhesive layer of the laminating material is fed as a solid with the laminate layer into the laminator. In the laminator, the laminating material is mated with the substrate, such as in the convergence zone, and then heat and pressure is applied, such as with heated rollers, to melt the adhesive and when the adhesive is allowed to cool, the laminate layer (or layers in two-sided processes) is bound to the substrate.

Curl or twist is an ongoing problem faced by the thermal laminating industry. Curl is waviness, bending, roll, or curvature that typically occurs at the edge of the laminate layer or laminated product. Curl can have a number of causes but generally is the result of internal stresses or bending forces created during stretching or manufacturing processes for the laminate layer. In other words, the laminate material (i.e., PET, OPP, nylon, and the like) has “memory” of its original form or orientation. In forming a sheet of laminate material of a desired thickness, a web of molten or hot laminate material at a first thickness and width is fed through a series of feed rollers that have increasing width to stretch the web of laminate material in a direction transverse to the supply or machine direction to a second or final thickness and width. A simple stretching process is illustrated in FIG. 1. Adhesive is then applied to one side of the stretched lamina web and the two layers of material are rolled to form a supply roll for a laminator or laminating process.

The stretching process results in a web of laminate material that is now an oriented film with a memory. The grain of the laminate material is generally along the machine path of the feeder rollers but is altered by the stretching processes. The created memory or internal stress is generally cross grain which causes relatively strong curling or bending forces to develop in the laminate material causing the material to attempt to roll itself into a cylinder with the center line of the sheet being the center axis of the cylinder. The problem is made more difficult to resolve as the memory created by the stretching process can vary significantly throughout the finished product or roll. Hence, when the laminate material is applied to a substrate, bending or curling forces of varying magnitude and direction are applied by the laminate layer at different points on the substrate such as at the corners or edges. For example, the laminated product shown in FIG. 2 is curling at two of its comers due to memory in the plastic used for the laminate film.

In two-sided lamination, curl has proven to be an even more complicated issue that has not been satisfactorily resolved by the laminating industry. Products that are created using two-sided thermal lamination have a top or first film of laminate material that attempts to curl based on its internal stresses or memory and have a bottom or second film of laminate material that also attempts to curl based on its internal stresses or memory. In general, two-sided lamination is performed by randomly selecting and orienting the top and bottom films which can result in one or more corners of the laminated product (e.g., as shown in FIG. 2) curling up or down as the combined bending forces of the two films typically will not offset each other and often may even be additive, i.e., the bending forces may both be in the same direction which significantly increases the likelihood of curling in the finished product.

One technique used to try to reduce curling has been to divide the produced laminate web into a number of supply rolls and then match rolls with laminate material from matched locations of the stretched web. This technique can best be understood with reference to FIG. 3 in which a stretched web of oriented laminate is separated (as shown by dashed cut lines) into five supply rolls with four having varying internal stresses or memory, i.e., North A, North B, South A, and South B. Then during two-sided lamination, rolls are paired based on their location in the original web in an attempt to supply opposing bending forces or opposite memories to the finished product to control curling. As shown in FIG. 4, the North A roll is matched with the South B roll and the North B roll is matched with the South B roll. While providing some improvements in curl control, this traditional technique is often ineffective or leads to inconsistent results as the memories or internal stresses are often not truly identical or in a direction opposite based simply on their location in the original web. For example, the bending forces existing in the North A roll may be greater than those in the South A roll and/or in a slightly different direction rather than being exactly in the opposite direction as those in the South A roll. Additionally, this technique requires that the rolls be accurately selected and marked for cutting into supply rolls and then accurately marked for proper orientation in a laminator, which can lead to errors and can add to manufacturing costs.

Hence, there remains a need for an improved method of controlling curl in two-sided lamination. Preferably, such a two-sided lamination method would create flat products, would be relatively simple and inexpensive to implement, and would be useful with existing laminators and other related equipment and with commonly used thermal films and adhesives.

### SUMMARY OF THE INVENTION

The present invention addresses the above curl problems by providing a two-sided lamination process that controls curl caused by memory in laminate material by matching or aligning the grain orientation of a top laminate sheet or film with the grain orientation of a bottom laminate sheet or film. In this manner, the bending forces created when the laminate films are bound to a substrate are nearly identical but in opposite directions so as to cancel each other and create a flat laminated product. To this end, the inventive method takes into account that memory or internal stresses vary across (e.g., transverse to the machine direction of the stretching apparatus) the web of laminate material and further recognizes that for a particular stretching apparatus or machine that the grain directions or memory of will remain more or less the same throughout a production run (or at least for portions of the production run) for each location or section of the web.

An important feature of the laminating method is to select laminating films from the same position on the stretched or oriented web for the top and bottom laminating films. To achieve opposing forces, opposite sides of the web from a particular web position are coated with adhesive to form the top and bottom laminating materials or supply rolls. In some embodiments, a first half of a film inventory from a particular web position is coated on the inside of the web and a second half of the film inventory from the same web position is coated on the outside of the web. Rolls of the two types of laminating material are then fed concurrently to a laminator to coat opposite sides of a substrate with laminate films with grain orientation or memory that creates substantially equal bending force but in an opposite direction (i.e., the grain orientation is substantially the mirror image in the two laminating films). Products created by the method are flat or nearly flat with little or no curling. Additionally, the creation of the supply rolls of laminate material, including proper selection and marking, is significantly simplified and can be performed as a secondary process to the stretching process. Further, it is not required that films from opposite web positions be purchased as sets to obtain flat lamination (as was required in prior art methods which may still not provide acceptable results) as flat, two-sided lamination can be achieved using the method of the present invention using any cut position of the oriented film web.

More particularly, a method is provided for creating paired or matched supplies of laminate material for use in two-sided lamination. The use of the paired supplies in two-sided lamination results in flat laminate products by providing laminating films on a substrate with bending forces of similar magnitude but oriented to act in opposite or nearly opposite directions. The method includes providing a quantity or inventory of laminate film (such as a plurality of rolls of laminate film). The laminate film is obtained from a section or position of a web formed during a stretching process, i.e., all the laminate film is from the same position along the web so as to have the same grain orientation. The method continues with identifying a first and a second side of the laminate film (such as the inner side and the outer side of the web in a roll) and then selecting a first and a second portion or set of the laminate film (e.g., dividing the rolls of laminate film into two groups). A layer of adhesive is then applied to the first side of the first portion of the laminate film and to the second side of the second portion of the laminate film. The method may further include marking or labeling the first and second portions of the laminate film with adhesive applied as a matched set for use as the two supplies of laminate material for a two-sided laminator.

According to another aspect of the invention, a laminated product is provided that is laminated on both sides but is still substantially flat or without curl. The product includes a substrate, such as paper or other material that is printed on both sides, with opposing first and second surfaces. A first layer of laminate is placed adjacent the first surface. The first layer of laminate is supplied from or obtained from a segment of a web of laminate material (such as PET, OPP, nylon, and the like) typically produced in a stretching process. A first adhesive layer is positioned between the first laminate layer and the first surface of the substrate to bind the first laminate layer to the substrate. A second layer of laminate is included and placed adjacent the second surface of the substrate. The second layer of laminate is also supplied or obtained from the segment of the web of the laminate material. The laminate material of the segment has a grain orientation that produces bending forces in the first and second layers of laminate that are substantially equal but significantly, are in opposite or nearly opposite directions such that no or little curling occurs in the product due to internal stresses in the laminate layers. The product includes a second adhesive layer between the second laminate layer and the second surface of the substrate, and, the adhesive layers are generally formed of an adhesive that is adapted for thermal activation. In some preferred embodiments, the finished product is a blind or shade used in the window covering industry and as such, the substrate and lamination layers are selected to suit the demands of consumers in this industry and may include tinted, metalized, sun/light block materials, and the like.

### BRIEF DESCRIPTION OF THE DRAWINGS

FIG. 1 is a simplified top view of a system used for stretching a web of laminate to a create a sheet of laminate film having a desired thickness;

FIG. 2 is a laminated product produced according to prior art techniques showing curling of two corners caused by memory or bending forces within a laminating film or films;

FIG. 3 is a top view of a system similar to that of FIG. 1 illustrating the division of the produced laminate film into multiple rolls having differing internal stresses and material memories;

FIG. 4 is a perspective view of the use of pairs of the supply rolls produced from the sheet shown in FIG. 3 to try to control curl by offsetting bending forces;

FIG. 5 is flow chart illustrating steps of an exemplary two-sided lamination process according to the present invention;

FIG. 6 is a perspective view of a roll of laminate film or a web of lamina created by a stretching process such as those shown in FIGS. 1 and 3 to create a film of material with internal stresses or memory;

FIG. 7 is a cross section of the laminate film showing the first and second side of the film and showing sections of the film material with particular internal stresses;

FIG. 8 is a cross sectional view similar to FIG. 7 showing two-sided lamination with adhesive applied to opposite sides of laminate film to provide opposing forces to control curling;

FIG. 9 is a cross sectional view similar to FIG. 8 illustrating a flat laminated product produced according to the methods of the present invention; and

FIG. 10 is flow chart providing exemplary process steps for the process of assembling a pressure vessel assembly according to the invention and of charging, using, and, in some cases, reusing the liner and/or vessel.

### DETAILED DESCRIPTION OF THE PREFERRED EMBODIMENTS

The present invention is directed toward a two-sided thermal lamination process, and to products made by such process, e.g., blinds and shades, ID cards, menus, and the like, that overcomes deficiencies with existing laminators and lamination processes that put curl into their thermal laminates. The curl is generally thought to be a by-product of the stretching process used to create supply rolls of laminate films having a desired thickness and is typically more of a problem with thicker films as bending forces are often more pronounced. Briefly, the method of the invention calls for thermal films to be initially fabricated in standard fashion via stretching a molten web of a laminate, such as PET, OPP, or nylon, and cutting the stretched web into a number of segments along the length of the web (e.g., five or more segments typically identified by position in the web such as North A, Nodith B, Central, South B, and South A). Each segment roll of laminate film is then placed into inventories based on position in the web from which the segment was taken.

The method then includes dividing an inventory (or even a single roll) from a particular position (and, in some cases, from a particular fabricating run or process) into two sets or into two halves. Adhesive is then applied to one side of one of the inventory sets, such as the inside of the web, and to the opposite or second side of the other inventory set, such as the outside of the web. The laminate material is then rolled and marked as a first and a second supply (i.e., a paired supply such as Supply A and Supply B). During lamination, a roll of the first supply and a roll of the second supply are fed concurrently along with a substrate such that laminate film from the same position is applied to each side of the substrate but in mirror image fashion to provide opposing forces that are identical or substantially identical in magnitude but opposite in direction. The laminated product is finished by activating the adhesive, cooling the adhesive, and, in necessary, cutting the combined layers to create a finished product that is laminated on opposing sides and that is flat, i.e., has no or little curling or bowing caused by memory of the two applied laminate films.

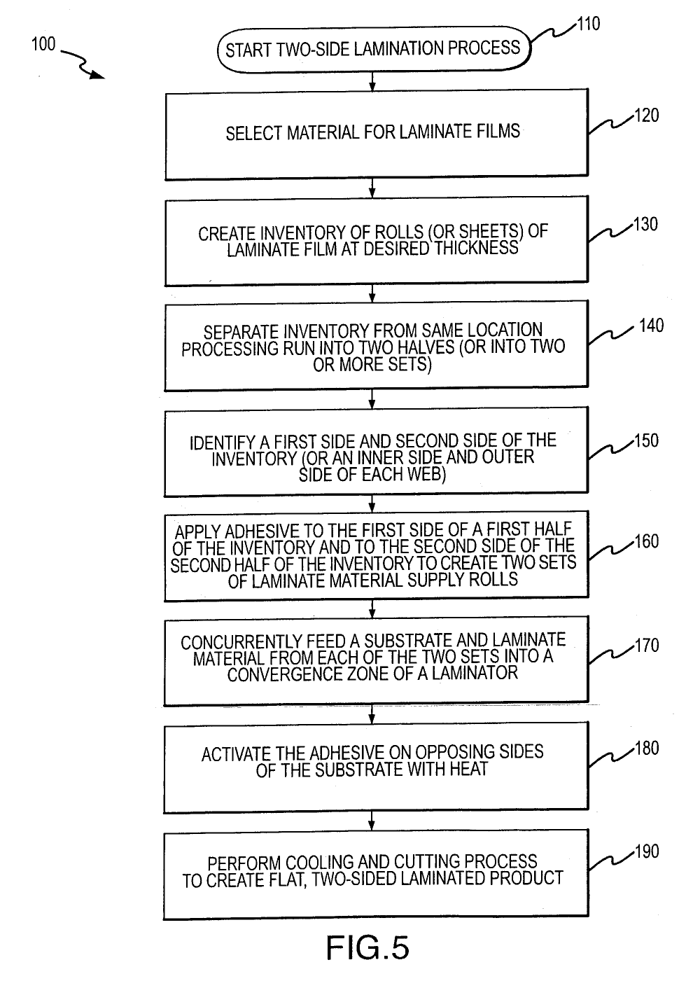

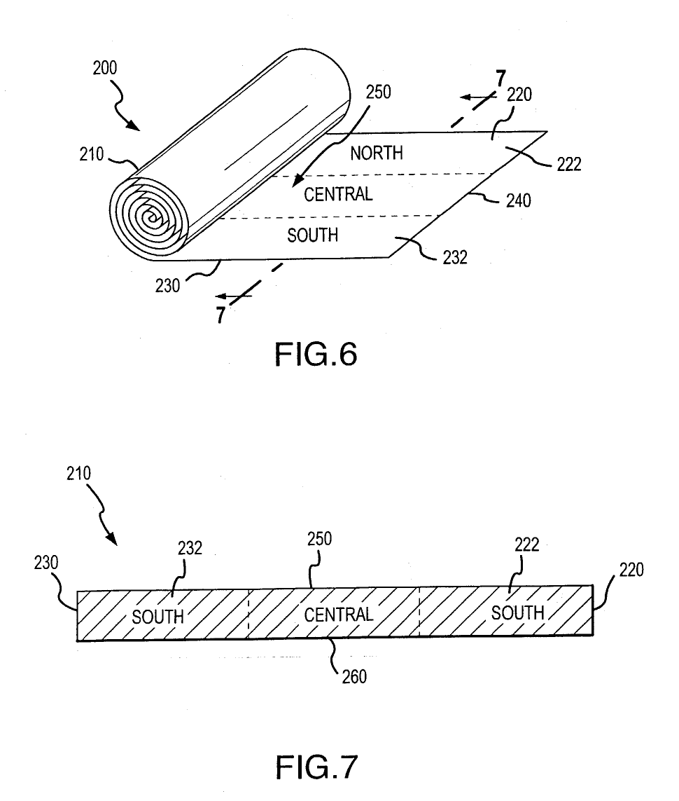

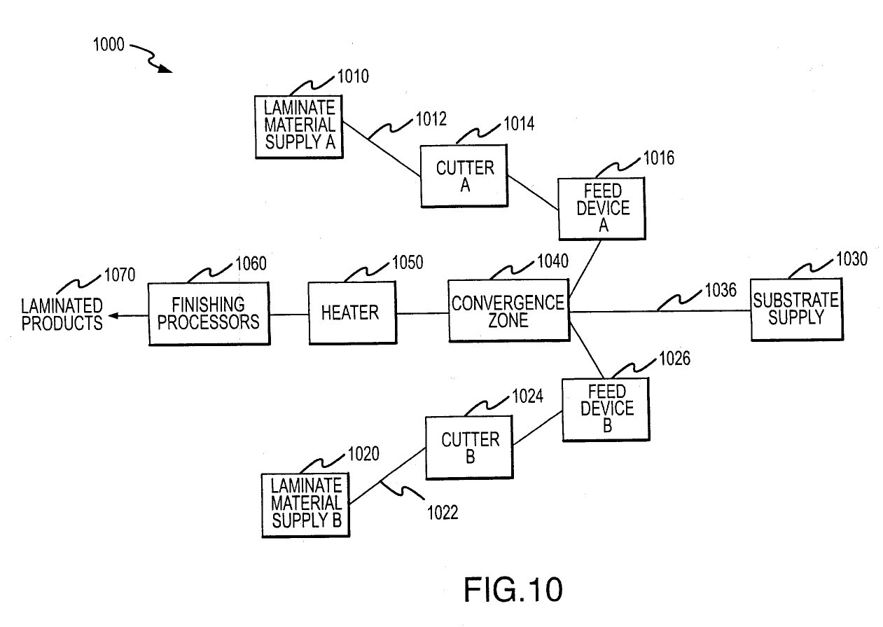

The following description begins with a description of an exemplary two-sided lamination process with reference to FIG. 5. This description provides an overall background to the inventive features of the invention. The description continues then with a discussion of how to create laminating material inventories that can be paired to provide opposing bending forces (or mirror image grain orientations) and how such inventories can then be used to create a flat two-sided laminated product with reference to FIGS. 6-9. FIG. 10 is provided to facilitate description generally a laminator useful for implementing the laminating method of the present invention to create flat products.

In FIG. 5, a two-sided lamination process 100 is shown that includes the basic steps that are followed according to the invention to create two-sided laminated products that are less susceptible to curl than products from traditional lamination. The process 100 starts at 110 typically with the planning of a lamination process including selecting potentially useful film materials, identifying substrate design, selecting potentially useful adhesives, and determining a laminator for use in applying the film materials including activating the adhesives. At 120, the material of the laminate films is identified and generally is PET, OPP, nylon, or other plastic used by the thermal laminating industry for protecting printed substrates. The laminate films are generally purchased in rolls and have a thickness that is greater than desired for most laminating processes.

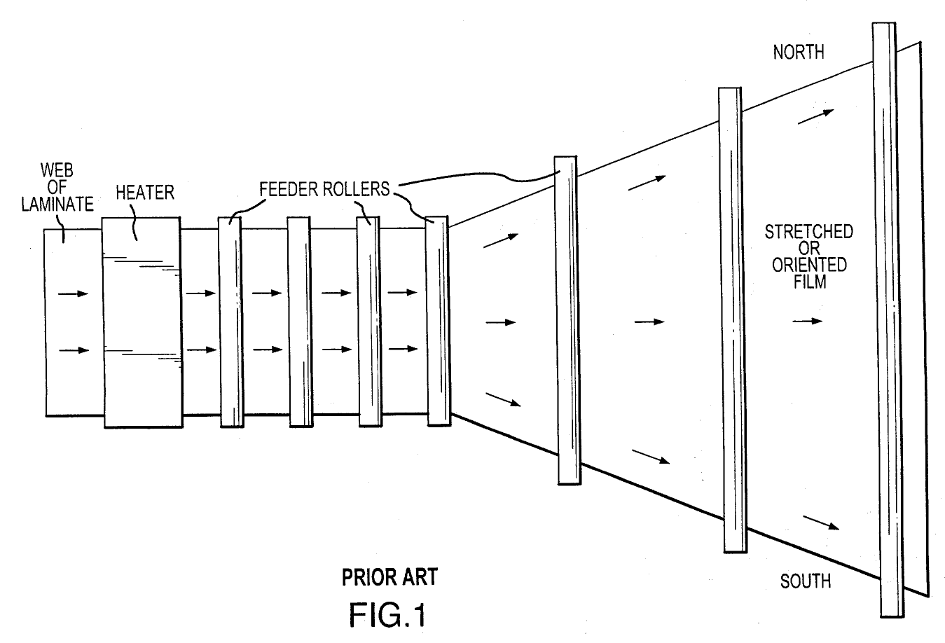

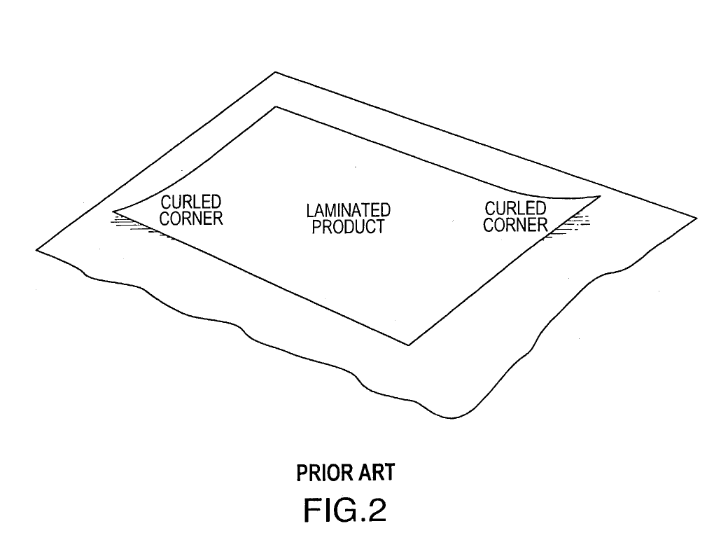

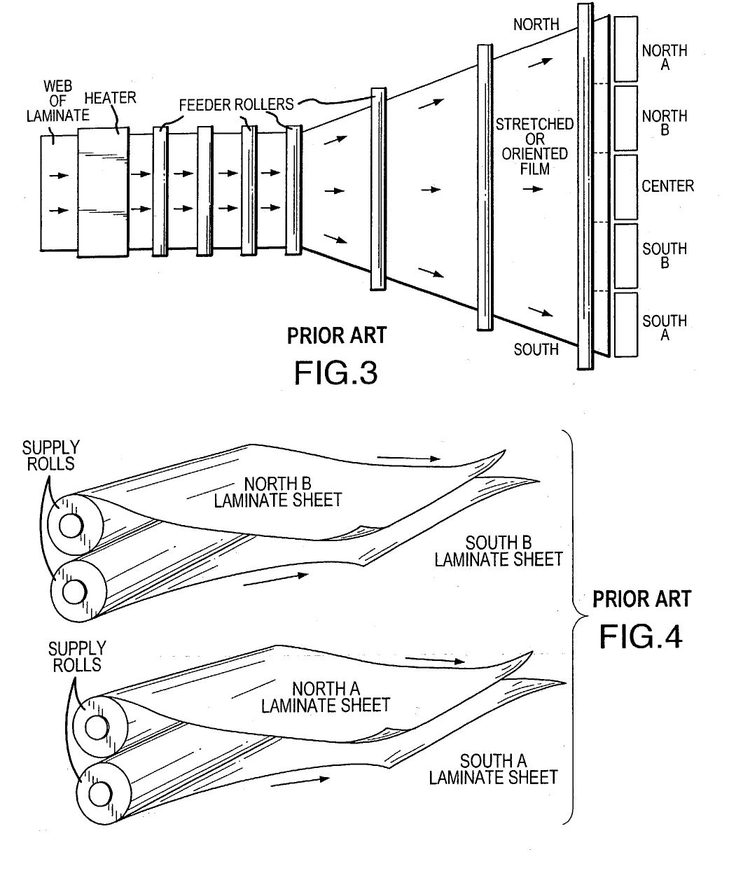

Hence, at 130, the web of laminate from the roll is fed into a stretching machine (such as those shown in FIGS. 1 and 3). The stretching is used to create a web of thermal film that has a desired thickness. As discussed previously, the stretching also orients the plastic or laminate material such that the material has a memory. The memory typically differs based on the location of the material in the web of the thermal film and can even vary along the length of the web (such as measured in the machine direction or feed direction). According to the invention, though, it is assumed that generally for a particular stretching machine configuration (or at least for a particular machine run that creates a web of laminate from which rolls of laminate are formed) that laminate film from particular positions in the web will be similarly oriented and have similar material memory that creates internal stresses or bending forces. With the importance of web position understood, the inventory is created at 130 by dividing the web of oriented material into a number of segments that are then marked or identified based on the web position of the laminate film and then, typically, rolled for storage and/or shipping. For example, FIG. 3 shows a web of stretched or oriented film that is segmented into five portions based on web position in the stretching machine. More particularly, in this example, a roll(s) of oriented film is produced from North A, North B, Center, South B, and South A web positions. The number of divisions or web positions is not limiting to the invention, as it should be understood that the important aspect is that the position on the web be identified to avoid mismatching or incorrect pairing in later method 100 steps. The number of web positions may range widely depending on the stretching process and laminate film, e.g., may range from1 (i.e., no segmenting being performed after stretching) to 5 to 10 or more.

At 140, the method 100 continues with selecting a position of the web to use in later lamination steps, such as position South A or position North B. The inventory created from this web position is then divided into two equal sets or two halves. If only one roll is available for a web position, this may simply involve using the first half of the roll as the first half of the inventory and the second half of the roll as the second half of the inventory (e.g., if the roll had a web length of 1000 feet, the first half of the inventory would be the first 500 feet of web to be taken off the roll). More typically, a stretching machine may be used to create a number of rolls of laminate web at each web position. In these cases, the separating at 140 involves identifying rolls of laminate web from a particular web position and then dividing the rolls into two equal sets (such as an inventory of 100 rolls being separated into two sets of 50 rolls from a particular web position). In some embodiments, the “inventory” is further defined to only include rolls from a particular web position for a particular processing run by a particular stretching machine or process. This is sometimes useful because even minor changes in the operating conditions or parameters for a stretching machine or process may create differing grain orientation in the produced web and pairing with laminating film from a different production run may result in less desirable results in controlling curl. Note, typically the inventory is divided in two halves but creation of the two, paired laminate material supplies may involve selecting any sized subset of the inventory for different treatment in step 150 (e.g., one fourth and one fourth of the rolls may be selected for the two portions of the base or original inventory of laminate film).

At step 150, a first side and a second side of each laminate film in each half or set of the inventory is identified. The first side and second sides are the same in each of the two sets of the laminate rolls. For example, the first side of the film in each inventory may be the inside of the web of the rolls and the second side may be the outside of the web of the rolls. This is explained in more detail with reference to FIGS. 6-9. At 160, an adhesive is applied to the first side of the laminate film (such as the inner side of the web) in the first set or first half of the inventory from the web position. Also, at 160, adhesive is applied to the second side of the laminate film (such as the outer side of the web) in the second set or second half of the inventory from the same web position. The webs are typically again rolled (after the adhesive is hardened) and the rolls of laminate material are then labeled to indicate proper pairing with other rolls. For example, rolls of laminate material from the first set or first half of the inventor may be labeled as “Supply A” and rolls of laminate material from the second set or second half of the inventory may be labeled as “Supply B” with the understanding that in two-sided lamination a roll of Supply A lamination material should be paired with a roll of Supply B lamination material.

At 170, a laminator adapted for two-sided lamination is loaded with a roll of laminate material created from the first half of the inventory and with a roll of laminate material created from the second half of the inventory and is further loaded with a substrate to be protected with the two laminate films. Further, at 170, the laminator (such as the laminator 1000 of FIG. 10) is operated to concurrently feed the laminate material with adhesive coated on the first side, the laminate material with adhesive coated on the second side, and the substrate so as to meet in a convergence zone with the two laminate materials being mated with opposing sides of the substrate (e.g., with adhesive against the substrate surfaces). At 180, the laminator is operated to activate the adhesive such as with pressure and heat to melt the adhesive. Finally, at 190, the adhesive is allowed to cool to bind the two laminate films to the substrate, and if necessary, cutting is performed to finish the product which is laminated on two sides and which is flat or substantially flat as any bending forces in the laminate films act counteract each other.

FIG. 6 illustrates a roll of laminating film 200 that may be output from a stretching process or machine (such as the devices shown in FIGS. 1 and 3). As shown in FIGS. 6 and 7, the roll 200 includes a web of laminate 210 with a top or north edge 220, a bottom or south edge 230, and a leading edge 240. The web 210 is separated or segmented into three web positions, i.e., a north web position segment 222, a central web position segment 226, and a south web position segment 232. Due to the stretching used to create the roll 200, each of these portions of the web 222, 226, 232 have differing grain orientation or material memories that when create bending forces typically at the edges that attempt to roll the portions 222, 226, 232 into a cylinder with a central axis parallel to the elongate axis of the roll 200. In creating inventories of thermal films, the web 210 typically is cut so as to create lengths or rolls of the film from each web position 222, 226, 232. As shown, in FIGS. 6 and 7, the web 210 has a first or inner side or surface 250 and a second or outer side or surface 260. Of course, the web 210 may be separated into fewer or greater numbers of web position-based segments to provide laminate films with a desired width as well as film thickness and these minor variations are considered a part of the present invention.

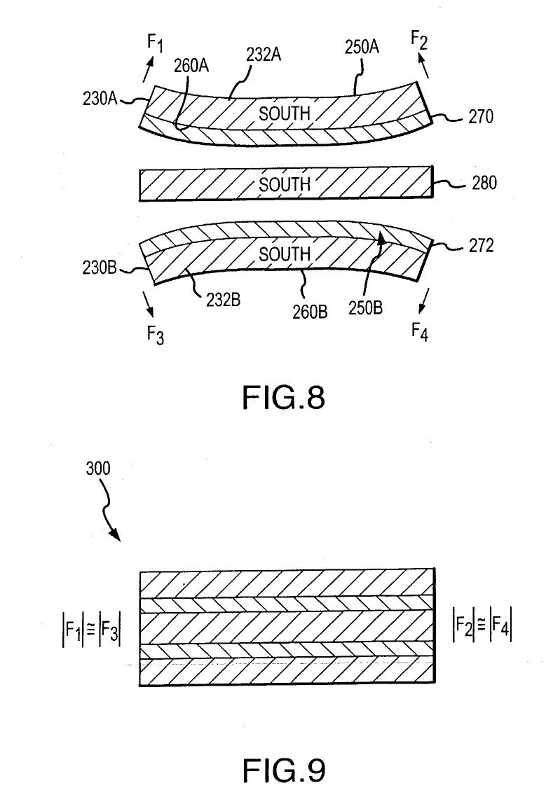

Once separated into webs of laminate or thermal film based on web position (such as North, South, and Central), the inventories of thermal film from each web position are first marked and separated based on web position (i.e., collecting film from each position of the web as separate film inventories). The inventories of each web position are then divided into two equal sets and adhesive is applied to opposite sides of each set of the film. For example, FIG. 8 illustrates laminate film 232A, 232B from a “South” web position inventory. The laminate film 232A was placed in a first half or set and the laminate film 232B was placed in a second half or set. A first side 260A, 260B was identified for each of the films 232A, 232B and a second side 250A, 250B was also identified for each of the films 232A, 232B. An adhesive layer 270 was applied to the first side of the laminate film 232A in the first half or set of the inventory, and an adhesive layer 272 was applied to the second side 250B of the laminate film 232B. In other words, the adhesive 270, 272 was placed on opposing sides of laminate films 232A, 232B from the same web position (i.e., the South position 232) of web 210 and as can be seen by the location of edges 230A and 230B.

FIG. 8 illustrates generally the positioning of the films 232A, 232B with adhesive layers 270, 272 relative to a substrate 280. This would typically occur within a laminator or laminating process such as in the convergence zone of the laminator when the laminating films 232A, 232B and the substrate 280 are concurrently fed into and through the laminator. As shown, the first side 260A of film 232A from the first half of the inventory is placed adjacent a first side of the substrate 280 while the second side 250B of the film 232B from the second half of the inventory from the same web position (such as the South position 232) is placed adjacent a second side (or the opposite or opposing side) of the substrate 280. The film 232A has a material memory that creates bending forces, F₁ and F₂, that attempt to curl the film 232A, and the film 232B has a material memory that creates bending forces, F₃ and F₄, that attempt to curl the film 232B.

Due to the selection of the films 232A and 232B from the same web position 232 and the coating of adhesive on opposite sides of the films 232A and 232B (or the alignment of the two films 232A, 232B relative to the substrate 280), the bending forces are act to balance or counteract each other such that, as shown in FIG. 9, the finished product 300 is flat or substantially flat with little or no curl at its edges. Such curl control is obtained because the bending forces, F₁ and F₂, are similar or identical in magnitude but in opposite directions as the bending forces, F₃ and F₄, respectively. This is shown in FIG. 9 with the absolute values of the bending forces at the edges of the two films 232A, 232B being shown to be substantially equal.

The lamination processes of the present invention may be performed utilizing numerous laminators and laminating equipment. Laminators useful for two-sided lamination are relatively well known in the art and many of these devices can be used to perform the inventive processes, such as but not limited to the laminating system described in U.S. Pat. No. 6,244,319 to Maynard et al. which is incorporated herein by reference and other laminating systems readily available within the thermal laminating industry. The important aspects of the system are that two sources of laminating material can be accessed to concurrently feed laminate material formed as discussed above with reference to FIGS. 6-9 and that such fed laminate material is positioned relative to a substrate as shown in FIGS. 8 and 9.

One exemplary (and simplified) laminator 1000 is shown in FIG. 10 that can be used to perform the processes of the invention (such as those described in FIG. 5) to produce flat, two-sided, laminated products. As shown, the laminator 1000 includes a laminate material supply 1010 for providing laminating material produced from a first half of an inventory from a particular web position and a laminate material supply 1020 for providing or feeding a laminating material produced from a second half of the same inventory. As discussed above, the laminate material from supply 1010 has adhesive coated on a first side and the laminate material from supply 1020 has adhesive coated on a second side, with the webs being similarly oriented. The laminating materials 1012, 1022 are fed to cutters 1014, 1024 to cut the laminating film and adhesive into sizes appropriate for the finished product 1070 (such as an ID card or other product). The cut laminate material is then fed to feed devices 1016, 1026 for concurrent feeding to the convergence zone 1040 for mating with a substrate 1036. The substrate 1036, e.g., printed paper, cardboard, plastic, and other materials, is likewise fed concurrently with the laminating material from the substrate supply 1030. Each of these devices may be configured in any useful manner, such as with rollers, to selectively feed the laminating and substrate materials to the convergence zone 1040.

In the convergence zone 1040, the laminating materials from the supplies 1010, 1020 are mated with the substrate 1036 such as shown in FIG. 8 to have the adhesive abut opposite sides of the substrate 1036. Heater 1050 is used to activate the adhesive layers in the laminating material, such as with heated rollers. At 1060, finishing processes, such as cooling and cutting, are performed to create the finished laminated products 1070 (such as shown in FIG. 9). The finished products 1070 are flat or substantially flat as the bending forces developed in the laminating films in the product 1070 are generally equal in magnitude but opposite in direction so as to cancel each other out and to fail to curl the products 1070.

A particular implementation of the above-described processes is in the window covering industry as part of the fabrication of window blinds, shades, and other window coverings that utilize lamination of a substrate. In the process of laminating together three or more films or layers to create blinds and shades, curl can be a significant problem and can result in unacceptable products. To solve the curling problem associated with lamination, the methods discussed with reference to FIGS. 5-10 can readily be used for creating laminated shades and/or blinds (with minor modifications in some cases).

To manufacture blinds and shades using film layers, it is necessary to laminate layers of films together such that the combined layers are strong and when installed, hang with no or minimal curl. Typically, the laminate films and/or the substrate will be tinted (such as to tint the light passing through) or otherwise treated to block or reduce the passage of light or even be opaque to fully block the passage of light. In many cases, the substrate discussed in FIG. 5 and shown as element 280 in FIG. 8 is block out or tinted material that is inserted or sandwiched between two laminate films (such as films 232A and 232B of FIG. 8) with optical characteristics to achieve a desired opacity and/or tinting of the incoming light. While it may be useful to have outer laminated films or parts A and B (e.g., the primary north and south films) metalized or tinted, it is more common (and useful for adding weight and structural strength for a blind or shade) to “sandwich” a layer of material between the two laminate films in fabricating shades and blinds. The insert material (such as substrate 280 in FIG. 8) may be a polyester, PVC, OPP, or nearly any variety of film or substrate used in the fabrication of blinds and shades in the window covering industry including dark black plastics used to block out light.

Further, the substrate or insert material may be a single layer of material or may include multiple layers and may be subjected to a foil or metalization process performed on it prior to insertion or prior to lamination (such as, with laminate films 232A and 232B). The substrate may include a vacuum metalized layer, a smoked layer, colored or tinted layers, an embossed film, and/or other material or treated layers and nearly any combination of such material layers. As with the other products described above, the inventive methods are useful in creating blinds and shades with little or no curl caused by the laminate films. Note, the laminated product produced by the method of the invention may be a primary portion of a blind or shade (e.g., one of the slats) or may be a subpart or component. This is achieve because the method of the invention provides proper alignment of top and bottom laminate films, e.g., north/south matching, to control curl and related production problems.

Although the invention has been described and illustrated with a certain degree of particularity, it is understood that the present disclosure has been made only by way of example, and that numerous changes in the combination and arrangement of parts can be resorted to by those skilled in the art without departing from the spirit and scope of the invention, as hereinafter claimed. For example, only rectangular laminating films or sheets are shown in the figures, but it will be understood that the principles of the invention cover any shape of laminate film when the films used for each side are obtained from the same position in the laminate web. The thickness of the laminating film is not limiting of the invention (as long as the films applied to the opposing sides are substantially the same which is the case if taken from the same web position and stretching process) but the inventive method is particularly useful as the thickness of the film increases and the resulting bending forces that need to be controlled increase.

I claim:

1. A method for creating paired laminate material supplies for use in two-sided lamination, comprising:
providing a quantity of laminate film, wherein the laminate film is formed in a stretching process that creates a web with a number of web positions, the quantity of laminate film being from a particular one of the web positions;
identifying a first side of the laminate film and a second side of the laminate film;
selecting a first portion of the quantity of laminate film and a second portion of the quantity of laminate film;
applying a layer of an adhesive to the first side of the laminate film in the first portion of the quantity of laminate film; and
applying a layer of the adhesive to the second side of the laminate film in the second portion of the quantity of laminate film.

2. The method of claim 1, further including labeling the first portion and the second portion as a matched set for concurrent use in two-sided lamination.

3. The method of claim 1, wherein the quantity of laminate film is a roll of laminate material.

4. The method of claim 1, wherein the quantity of laminate film is formed during a single configuration of the stretching process.

5. The method of claim 1, wherein the first portion is equal in length to the second portion.

6. The method of claim 1, wherein the laminate film comprises a plastic selected from the group consisting of polyester, polypropylene, and nylon.

7. The method of claim 1, wherein the adhesive is adapted for thermal activation.

8. A two-sided thermal lamination method for controlling curl, comprising:
feeding a first laminate material to a convergence zone, the first laminate material comprising a film from a web position of a web of laminate created by a film forming process and an adhesive layer abutting a first side of the laminate film;
concurrently with the feeding of the first laminate material, feeding a second laminate material to the convergence zone, the second laminate material comprising a film from the web position of the web of laminate created by the film forming process and an adhesive layer abutting a second side of the laminate film, the second side being the opposite side of the web of laminate; and
feeding a substrate into the convergence zone between the first laminate material and the second laminate material, wherein the adhesive layer of the first laminate material abuts a first side of the substrate and the adhesive layer of the second laminate material abuts a second side of the substrate opposite the first side.

9. The method of claim 8, further including after the feeding of the substrate, activating the adhesive to attach the film of the first laminate material to the first side of the substrate and to attach the film of the second laminate material to the second side of the substrate.

10. The method of claim 8, wherein the film forming process includes stretching of the web of laminate, whereby the film in the web position is oriented based on the web position.

11. The method of claim 10, wherein the film in the web position comprises a plastic.

12. The method of claim 11, wherein the plastic is polyester, polypropylene, or nylon.

13. The method of claim 8, further including:
receiving an inventory of the film from the web position;
dividing the inventory into two sets;
identifying the first side and the second side of the film; and
applying the adhesive layers to the first and the second sides.

14. The method of claim 13, wherein the inventory is a plurality of rolls of the film and the dividing includes separating the rolls into the two sets, and further including after the applying of the adhesive layers, marking the two sets to pair the first laminate material to the second laminate material.

15. The method of claim 8, further including after the feeding of the substrate, using the laminated substrate to fabricate a window blind or shade.

16. The method of claim 1, wherein the first laminate material, the second laminate material, or the substrate comprises a tinted material, a smoked material, or a metalized material.

17. A product made by the method of claim 8.

18. A laminated product, comprising
a substrate with opposing first and second surfaces;
a first layer of laminate adjacent the first surface of the substrate, the first layer of laminate being supplied from a segment of a web of laminate material produced in a stretching process;
a first adhesive layer between the first surface of the substrate and the first layer of laminate;
a second layer of laminate adjacent the second surface of the substrate, the second layer of laminate being supplied from the segment of the web of laminate material produced in the stretching process; and
a second adhesive layer between the second surface of the substrate and the second layer of laminate.

19. The product of claim 18, wherein the laminate material of the segment has a grain orientation producing bending forces in the first and second layers of laminate having a substantially equivalent magnitude and a substantially opposite direction.

20. The product of claim 19, wherein the web of laminate material has an additional segment and wherein the laminate material in the additional segment has a grain orientation differing from the grain orientation of the laminate material in the segment.

21. The product of claim 19, wherein the laminate material is polyester, polypropylene, or nylon and the first and second adhesive layers comprise a thermally activated adhesive.

22. The product of claim 18, wherein the laminate material or the substrate is treated to control passage of light.

23. The product of claim 22, wherein the product is a component of a window covering assembly.
